(19) United States
(12) Patent Application Publication
(10) Pub. No.: US 2004/0062369 A1
(43) Pub. Date: Apr. 1, 2004

(54) Data communication system and medium for storing communication control program

(75) Inventor: Takashi Tsuji, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 10/661,678

(22) Filed: Sep. 15, 2003

Related U.S. Application Data
(63) Continuation of application No. 09/333,266, filed on Jun. 15, 1999.

(30) Foreign Application Priority Data
Jun. 15, 1998 (JP) 10-167083

(51) Int. Cl. H04M 11/00

(52) U.S. Cl. 379/93.09

(57) ABSTRACT

An object of the present invention is to readily open a data file to the public. In a communication system of the present invention, a call setting control signal is given from a reading side communication terminal to an opening side communication terminal at first in reading a data file within a storage unit of an opening unit by using a reading unit. A communication mode discriminating section within the opening side communication terminal judges whether or not data communication is requested based on information elements within the call setting control signal. When the data communication is requested, a communication control section within a server within the reading unit connects a line for the communication between those two communication terminals and establishes a logical communication path of the data communication. When the information terminal of the reading unit requests further to read a data file other than the data files within the storage unit after starting the data communication, a data file within the storage unit is transmitted.

### BACKGROUND OF THE INVENTION

1. Field of the Invention

The present invention relates to a data communication system and a medium for storing a communication control program for data communication using a public line network which enables the data communication.

2. Description of the Related Art

So-called Internet is used lately in transmitting/receiving data among a plurality of information processors. FIG. 8 is a conceptual view of a communication system 1 using Internet. The Internet 3 is a congregate of computer networks mutually connected via communication lines and allows server computers (hereinafter abbreviated as “server”) 5 through 8 within each computer network to transmit/receive data each other. Each of the servers 5 through 8 stores a data file 14 to be opened to the public on the Internet 3 in a storage unit within each of the servers 5 through 8.

Lately, a so-called Internet connection dealer or an Internet service provider (hereinafter abbreviated as “provider”) 9 has come on the stage. The provider 9 is provided with a computer network which constitutes a part of the Internet 3 and provides a service for connecting information terminals to the Internet 3. The information terminal is a personal computer or a portable information terminal for example.

The information terminal 11 obtains the data file 14 via the network of the provider 9 by using the following procedure in general. It is noted the user of the information terminal 11 must make a contract with the provider 9 in advance concerning to the connection with the Internet 3 and the information terminal 11.

In order to obtain the data file 14, the information terminal 11 connects a line between a communication terminal 12 connected with the information terminal 11 and the server 8 within the computer network owned by the provider 9 via a public line network 13 at first. Next, a logical communication path for data communication is established between the information terminal 11 and the server 8 of the provider 9 via the communication terminal 12 and the public line network 13. As a result, it enables data communication between the information terminal 11 and the server 8 of the provider 9. After establishing the logical communication path, the information terminal 11 transmits control information for specifying the server 5 provided with the data file 14 to be obtained and a storage unit 10 storing it and for making a request to transmit the data file 14 to the server 8 of the provider 9. As a result, the server 8 of the provider 9 obtains the data file 14 from the storage unit 10 and transmits the data file 14 to the information terminal 11 via the Internet 3. The information terminal 11 can obtain the data file 14 within the storage unit 10 of the server 5 of the Internet 3 by such procedure.

The data file 14 opened to the public on the Internet 3 includes a data file in which data to be opened to the public is described in the HTML (Hyper-Text Markup Language) scheme, or a so-called hyper-text file. When the offerer of the data creates the data file 14 by directly using the Server 5 within the Internet 3, the data file 14 is transmitted directly from the server 5 to the storage unit 10 and is stored therein. When the offerer creates the data file 14 by using an information terminal 16, data communication between the information terminal 16 and the server 8 of the provider 9 is enabled via a communication terminal 17 and a public line network 18 at first by the same procedure when the above-mentioned information terminal 11 has obtained the data file 14, and then the data file 14 is transmitted from the information terminal 16 to the server 5 to be stored in the storage unit 10 via the communication terminal 17, the public line network 18, the server 8 of the provider 9 and the Internet 3. In the case of the latter, there is a case where data communication between the server 5 and the information terminal 16 is enabled instead of the server 8 of the provider 9 and then the data file 14 is transmitted to the server 5 from the information terminal 16 via the communication terminal 17 and the public line network 18.

Conventionally, a public telephone switched network for speech communication is used for the public line networks 13 and 18. Information to be transmitted, e.g., a speech, is converted into analog signals to be sent/received in the public telephone switched network. The lines of the subscribers to which the communication terminals 12 and 17 are connected in the public telephone switched network are used not only for data communication but alto for speech communication often when the public telephone switched network is used. Therefore, the communication terminals 12 and 17 or the information terminals 11 and 16 are required to discriminate whether a signal supplied from the public telephone switched network to the communication terminals 12 and 17 is a signal for speech communication or for data communication. Technologies concerning on the switching of the speech communication and the data communication in the public telephone switched network have been disclosed respectively in Japanese Unexamined Patent Publications JP-A-6-62148, JP-A-8-116374, JP-A-7-7564, JP-A-6-152790 and JP-A-7-58877.

A complex terminal unit in JP-A-6-62148 detects at first whether an arrival signal of facsimile communication or a receive request signal of data communication is supplied further only for a predetermined period of time from the point of time when a ringing signal is supplied from the public telephone switched network to the complex terminal unit. Next, after the period of time passed, the complex terminal unit selects either speech communication, facsimile communication or data communication corresponding to the result of detection of the signal and starts a process for either one communication. Therefore, the complex terminal unit takes time until when the process for either one communication is started since when the ringing signal has been given.

A communication switching scheme in JP-A-8-116374 is used in communication between two data terminals having a telephone function. At first, one data terminal on the call incoming side sounds a call incoming bell at the point in time when a call signal is given. When the telephone receiver of the one data terminal is put into off-hook state by its user within a first predetermined time from that point and is put into on-hook state within a second predetermined time from the point in time of the off-hook, that one data terminal transmits a carrier to the other data terminal on the calling side. Responding to the carrier transmitted, the other data terminal starts to send data. It is difficult for general communication terminals and information terminals to have data communication based on the communication switching scheme because the two data terminals must operate respectively based on the communication switching scheme.

A plurality of transmitters are provided in a data telephone switching system in JP-A-7-7564. An anode of a plurality of diodes are connected to one signal line to which a switching circuit within each transmitter make reference in switching and a cathode of all of the diodes are grounded via a plurality of individual switches in the plurality of transmitters. When one switch among the plurality of switches is energized, it can be seen that any one among the plurality of transmitters is requested to have a speech communication. The transmitter relates to the simplification of the circuit for switching speech communication and data communication and does not relate to control of the data communication after the switching.

A multi-media detecting scheme in JP-A-6-152790 is used for communication between two communication apparatuses. At first, one communication apparatus on the data transmitting side specifies whether or not to make a communication using respective ones of a plurality of kinds of media continuously in starting the communication. The other communication apparatus on the data receiving side keeps to connect a line with that one communication apparatus until when the communication of all of the media ends in the case where the continuation of the communication of the plurality of media has been specified or disconnects the line at the stage when the communication of the single medium ends in the case where the continuation has not been specified. The two communication apparatuses must be equipped with parts related to the specification. Therefore, it is difficult for the general communication terminals and information terminals to have data communication based on the multi-media detecting scheme described above.

A communication apparatus in JP-A-7-58877 detects a CNG signal of facsimile communication and a PB signal of data communication respectively for each predetermined time from the point in time when a ringer signal is given from the public telephone switched network to the communication apparatus. Then, when the communication apparatus detects the CNG signal or the PB signal after the elapse of that time, it starts a process for facsimile communication or data communication. When it detects no such signals, it starts a process for speech communication after detecting that a telephone in the communication apparatus is hooked off. The communication apparatus also takes time until when the process for either one of the communications is started since when the ringer signal is given.

Japanese Unexamined Patent Publication JP-A-9-261370 has disclosed a technology for allowing a plurality of dial numbers to be set in one line and for switching data communication and facsimile communication by using a line network in which the call number of each dial number is different from each other. When a call signal is given from the line network, a communication apparatus on the call incoming side within the communication system of JP-A-9-261370 analyzes a signal pattern of the call signal and switches facsimile communication and data communication corresponding to the result of the analysis. It is difficult to use such communication system in a communication network in which one dial number is set for one line because such communication system is premised to be used in the above-mentioned line network.

Lately, a digital line network, i.e., a communication network for transmitting/receiving data to be transmitted in a digital signal form, has come to be used as a public line network. The digital line network includes, for example, a digital type portable telephone network, a PHS (Personal Handyphone System) network and an Integrated Services Digital Network (hereinafter abbreviated as ISDN). A communication protocol using the digital line network is constructed so that a communication terminal on the call incoming side can find a communication mode requested by a communication terminal on the calling side at the point in time when a line between those two communication terminals is connected. The communication mode indicates, for example, whether the communication which the communication terminal on the calling side tries to make is data communication, speech communication or facsimile communication.

Japanese Unexamined Patent Publication JP-A-7-107194 discloses a technology for using both data communication and speech communication in using a so-called automatic call incoming function of data communication in a digital cellar type portable telephone using the digital line network as described above. An adapter for an external terminal in JP-A-7-107194 is interposed between an external terminal and the portable telephone to connect them. When the automatic call incoming function is executed, the portable telephone enters a speaking state automatically corresponding to a signal from the line network. It then checks which of data communication and speech communication is requested based on an INFO signal given from the line network and gives its result to the adapter for the external terminal. The adapter for the external terminal performs the data communication when the data communication is requested or causes the portable telephone to generate a predetermined number of times of ringers when the speech communication is requested.

As described above, it is necessary to always connect the server 5 provided with the storage unit 10 in which the data file 14 is stored to the Internet 3 in order to open the data file 14 to the public on the Internet 3. Therefore, when the offerer uses the information terminal 16 to create the data file 14, it is necessary to transfer the data file 14 to the borrowed storage unit 10 to store therein. Due to that, the offerer must make a contract for borrowing the storage unit 10 with the owner of the server 5 in advance. Still more, in such a case, the offerer needs to recreate the data file 14 by using the information terminal 16 and to transmit the recreated data file 14 to the server 5 again in order to correct part of the data file 14 opened to the public. Therefore, it takes time to correct a data file opened to the public.

A so-called dedicated line is used as the communication line between the server 5 and the Internet 3 to connect the server 5 always to the Internet 3. It is difficult to use the dedicated line also for speech communication while using for the connection between the server 5 and the Internet 3. In many cases, the offerer himself manages the server 5 in creating the data file 14 to be opened to the public by using the server 5. Due to that, the offerer is required to have both of the line for speech communication and the dedicated line.

Still more, it is difficult to read the data file 14 for ones other than those who have made a contract with the provider 9 or who can use the servers 5 through 8 because the data file 14 is opened to the public on the Internet 3. Moreover, in the case where a communication line is to be connected with the server 5 by using the technologies described in the plurality of above-mentioned publications, the data communication between the server 5 and the information terminal 11 is started unconditionally when the information terminal 11 to which the communication is to be made requests data communication. Therefore, it is difficult for the server 5 to limit ones who open the data file 14 in such a case.

### SUMMARY OF THE INVENTION

It is an object of the present invention to provide a data communication system and a medium for storing a communication control program for opening a data file to an unspecified number of persons readily more than the case of opening the data file to the public by using Internet.

The invention provides a data communication system comprising:

request judging means for judging whether or not a terminal unit of a caller is requesting data communication based on a call signal given from the terminal unit;

connection instructing means for instructing to connect a line for transmitting/receiving signals to/from the terminal unit;

line control means for connecting the line in response to an instruction from the connection instructing means;

transmission/receiving control means for data communication, capable of controlling transmission/receiving of signals indicative of data on the basis of a communication protocol preset for the data communication; and

communication control means, in response to a result of judgement of the request judging means, for, in the case where the data communication is requested, causing the line control means to connect the line to compare an authorization given from the terminal unit via the line with a reference authorization defined in advance and for causing the transmission/receiving control means to start to control the transmission/receiving of the signals only when the authorization coincides with the reference authorization.

According to the invention, the data communication system either one of the data communication or a communication other than the data communication with the terminal unit based on the request from the terminal unit. When the terminal unit requests the data communication, the line is connected regardless whether or not the connection instructing means instructs to connect the line, i.e., even in the so-called on-hook state, because the communication control means controls the line connecting means as described above. Thus, the data communication system can start the data communication automatically when the data communication is requested. The communication control means also operates as described above before the start of the data communication. The authorization is what discriminates the terminal unit or an operator of the terminal unit for example. As a result, the data communication system can limit the communication apparatus of the caller or the operators of the communication apparatus of the caller on data communication.

In the invention it is preferable that the data communication system further comprises:

storing means for storing at least one of predetermined sets of transmission object data, and

when the terminal unit requests to transmit data other than the predetermined sets of transmission object data after starting the control of the transmission/receiving of the signal, the communication control means causes the transmission/receiving control means to convert any one of the predetermined sets of transmission object data into signals on the basis of the communication protocol and transmit the signals, and

when the terminal unit requests to transmit any one of the predetermined sets of transmission object data, the communication control means causes the transmission/receiving control means to convert the requested set of transmission object data into signals on the basis of the communication protocol and transmit the signals.

According to the invention, the communication control means of the data communication system is arranged so as to operate as described above corresponding to whether or not the set of data requested by the terminal unit to transmit is any one of the predetermined sets of transmission object data. Thereby, the data communication system can automatically correspond to the request of an arbitrary set of data from the terminal unit and transmit any one set of transmission object data.

In the invention it is preferable that the data communication system comprises storing means for storing at least one of the predetermined sets of transmission object data; that the terminal unit transmits the request to transmit any one of the predetermined sets of transmission object data and one or more predetermined conditions of judgment, after starting the control of the transmission/receiving of the signal; and that the communication control means judges whether or not the transmitted one or more conditions of judgment satisfy one or more predetermined reference conditions for allowing the requested set of transmission object data to be transmitted in response to the request from the terminal unit and only when the one or more conditions of judgment satisfy the one or more predetermined reference condition the communication control means causes the transmission/receiving control means to convert the requested set of transmission object data into signals on the basis of the communication protocol and transmit the signals.

According to the invention, the communication control means of the data communication system is arranged so as to operate as described above when the terminal unit requests to send the transmission object data. As a result, the data communication system can limit the terminal unit which can receive the transmission object data based on the condition of judgment.

In the invention it is preferable that a data communication system further comprises storing means for storing at least one of predetermined sets of transmission object data; that the terminal unit transmits the request to transmit any one of the predetermined sets of transmission object data and one or more predetermined conditions of judgment after starting the control of the transmission/receiving of the signal; and that the communication control means judges whether or not the transmitted one or more conditions of judgment satisfy one or more predetermined reference conditions for allowing the requested set of transmission object data to be transmitted in response to the request from the terminal unit and when the one or more conditions of judgment satisfy the one or more predetermined reference condition the communication control means causes the transmission/receiving control means to convert the requested set of transmission object data into signals on the basis of the communication protocol and transmit the signals, and when the one or more conditions of judgment do not satisfy the one or more reference conditions the communication control means causes the transmission/receiving control means to convert transmission object data other than the requested transmission object data into signals on the basis of the communication protocol and transmit the signals.

According to the invention, the communication control means of the data communication system is arranged so as to operate as described above when the terminal unit requests to send the set of transmission object data. Thereby, the data communication system can change the set of transmission object data corresponding to the condition of judgment.

In the invention it is preferable that one of the one or more conditions of judgment is the specification of the terminal unit related to processing of the set of transmission object data.

According to the invention, the communication control means of the data communication system can control the transmission of the set of transmission object data by using the specification of the terminal unit as the condition of judgment, by the following reasons. For instance, the specifications of a display unit, i.e., type, size and standard of the display unit, within an unspecified number of terminal units differ from each other. Therefore, when one set of transmission object data is given respectively to the unspecified number of terminal units to display, the set of transmission object data may not be visibly displayed on all of the terminal units because the data display modes are different corresponding to the specification of the display units. Thus, the set of transmission object data may not be processed in the same manner in all of the terminal units when the same transmission object data is given to the plurality of terminal units whose specifications are different. Therefore, the data communication system uses the specification of the terminal unit as the condition of judgment and does not transmit the set of transmission object data to a terminal unit which is unable to process the set of data in the condition intended by the creator of the set of transmission object data.

In the invention it is preferable that the terminal unit further comprises imaging means for imaging the set of transmission object data, and one of the one or more conditions of judgment is the specification of the imaging means related to imaging the set of transmission object data.

According to the invention, the communication control means of the data communication system can control the transmission of the set of transmission object data by using the specification of the imaging means as the condition of judgment, by the following reasons. When the set of transmission object data is a so-called hypertext file, the imaging means may be realized by a computer controlled by a so-called browser software. The display modes of the hypertext differ depending on the specification of the browser software. Thus, the set of transmission object data may not be visibly displayed in all of the terminal units depending on the specification of the imaging means, i.e., on the specification of the browser software for controlling the computer. Therefore, the data communication system uses the specification of the imaging means as the condition of judgment and does not transmit the set of transmission object data to the terminal unit which is unable to display the set of data in the condition intended by the creator of the set of transmission object data.

In the invention it is preferable that the line contains a part of a public line network, and one of the conditions of judgment is an identification number for discriminating the terminal unit within the public line network.

According to the invention, the communication control means of the data communication system uses the identification number as the condition of judgment. Thereby, the data communication system can anticipate the operator of the communication system based on the identification number signal and can control the communication of the set of transmission object data corresponding to the anticipated operator.

In the invention it is preferable that one of the one or more conditions of judgment is predetermined authorization.

According to the invention, the communication control means of the data communication system uses the authorization as the condition of judgment. Thereby, the data communication system can anticipate the operator of the communication system based on the authorization and can control the communication of the set of transmission object data corresponding to the anticipated operator.

In the invention it is preferable that the data communication system further comprises received-data storage means capable of-storing data and that the communication control means stores data indicated by the received signals in the received-data storage means.

According to the invention, the communication control means of the data communication system operates as described above. As a result, not only transmitting data automatically, the data communication system can automatically receive data and store it.

In the invention it is preferable that the communication protocol is a communication protocol used for data communication on Internet.

According to the invention, the transmission/receiving control means of the data communication system transmits/receives data by using the communication protocol used in data communication on Internet. As a result, an apparatus which can implement the so-called dial-up and which is capable of utilizing Internet may make the data communication with the data communication system as the terminal unit.

In the invention it is preferable that the data communication system is capable of making data communication with a terminal unit of a caller via a communication apparatus which comprises connection instructing means for instructing to connect a line for transmitting/receiving signals and line control means for connecting the line with the terminal unit in response to the instruction from the connection instructing means, and comprises request judging means for judging whether or not the terminal unit is requesting data communication on the basis of a call signal given from the terminal unit of the caller, transmission/receiving control means for data communication, capable of controlling transmission/receiving of signals indicative of data based on a communication protocol preset for the data communication, and communication control means for causing the line control means to connect the line when the data communication is requested in response to a result of judgment of the request judging means, for comparing authorization given from the terminal unit via the line with reference authorization defined in advance and for causing the transmission/receiving control means to start to control the transmission/receiving of the signals only when the authorization coincides with the reference authorization.

According to the invention, the data communication system is used in combination with the above-mentioned communication apparatus. Thereby, the data communication system can start the data communication automatically based on the same reason with the data communication system of invention and can limit the communication apparatus of the caller or the operator of the communication apparatus of the caller in the data communication.

The invention provides a medium storing a communication control program for causing a computer to have data communication with a terminal unit of a caller via a communication apparatus which comprises connection instructing means for instructing to connect a line for transmitting/receiving signals, and line control means for connecting the line with the terminal unit of the caller in response to the instruction from the connection instructing means,

wherein the communication control program causes the computer to judge whether or not the terminal unit is requesting data communication based on a call signal given from the terminal unit, causes the line control means to connect the line when the data communication is requested, causes the computer to compare authorization given from the terminal unit via the line with the reference authorization defined in advance and causes the transmission/receiving control means to start to control the transmission/receiving of the signals indicating data based on a communication protocol preset for data communication only when the authorization coincides with the reference authorization.

According to the invention, the communication control program stored in the medium operates the computer as described above. As a result, the computer operates as the data communication system of the invention. Thereby, the unit in which the computer controlled by the communication control program and the communication apparatus are combined can start the data communication automatically based on the same reason with the data communication system of the invention and can limit the communication apparatus of the caller or the operator of the communication apparatus of the caller in the data communication. Accordingly, the data communication system of the invention may be realized easily by using the general purpose computer.

### BRIEF DESCRIPTION OF THE DRAWINGS

Other and further objects, features, and advantages of the invention will be more explicit from the following detailed description taken with reference to the drawings wherein:

FIG. 1 is a block diagram showing the schematic structure of a communication system 22 using a data communication system 21 according to one embodiment of the invention;

FIG. 2 is a block diagram showing the structure of an opening unit 24 for opening a data file 58 within the communication system 22;

FIG. 3 is a first half part of a flowchart for explaining a receiving process of the opening unit 24 in opening the data file 58 by using the communication system 22;

FIG. 4 is a second half part of the flowchart for explaining the receiving process of the opening unit 24 in opening the data file 58 by using the communication system 22;

FIG. 5 is a diagram of sequence for explaining signal transmitting/receiving operations within the communication system 22 in opening the data file 58 by using the communication system 22;

FIGS. 6A through 6F show concrete structures of the opening unit 24;

FIG. 7 shows a concrete method for utilizing the communication system 22; and

FIG. 8 is a block diagram showing the schematic structure of a prior art communication system 1 for opening a data file 14 by using Internet 3.

### DETAILED DESCRIPTION OF THE PREFERRED EMBODIMENTS

Now referring to the drawings, preferred embodiments of the invention are described below.

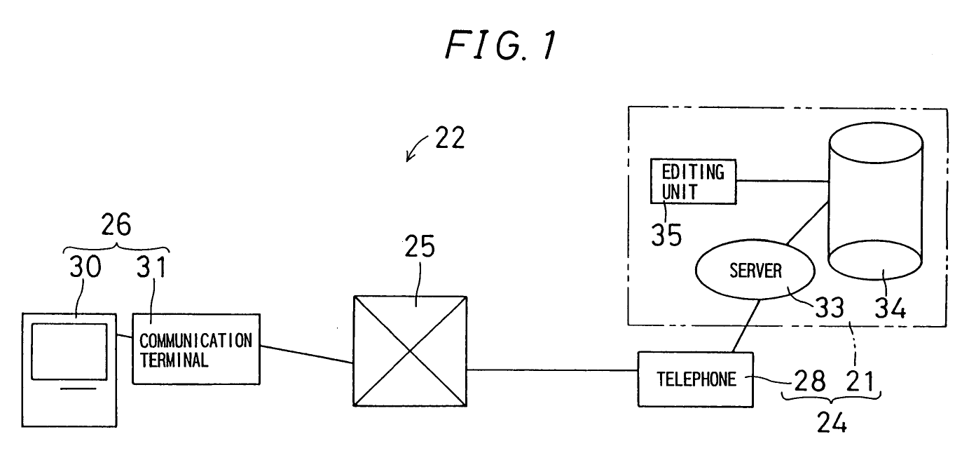

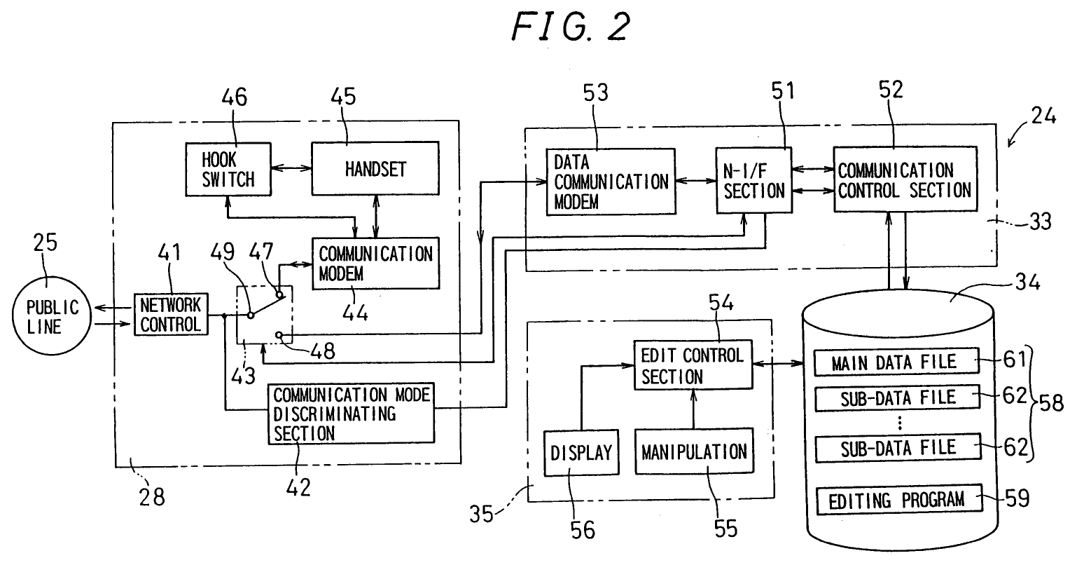

FIG. 1 is a block diagram showing the structure of a communication system 22 including a data communication system 21 according to one embodiment of the invention and FIG. 2 is a block diagram showing the electrical structure of the data communication system 21. FIGS. 1 and 2 will be explained together.

The communication system 22 comprises the opening unit 24 for opening data, a public line network 25 and a reading unit 26 for reading the data. The opening unit 24 comprises an opening side communication terminal 28 and the data communication system 21. The reading unit 26 comprises an information terminal 30 and the reading side communication terminal 31. The data communication system 21 comprises a server 33, a storage unit 34 and an editing unit 35. Although there is shown only one reading unit 26 in FIG. 1, there may be a plurality of reading units 26. A communication terminal other than the reading unit 26 such as a telephone, a facsimile or a communication apparatus capable of conducting data communication may be connected to the public line network 25 further.

The opening side communication terminal 28 comprises a network control circuit 41, a communication mode discriminating section 42, a switching circuit 43, a speech communication modem 44, a handset 45 and a hook switch 46. The server 33 comprises a network interface section 51 (hereinafter abbreviated as “N-I/F section 51”), a communication control section 52 and a data communication modem 53. One individual contact 47 among two individual contacts 47 and 48 in the switching circuit 43 is connected to the speech communication modem 44 and the other individual contact 48 is connected to the data communication modem 53. A common contact 49 in the switching circuit 43 is connected to the network control circuit 41. In the initial state, the common contact 49 is connected with one individual contact 47 within the switching circuit 43. The storage unit 34 stores at least a plurality of data files 58 to be opened to the public and an editing program 59 for editing the data file 58. The editing unit 35 comprises an edit control section 54, a manipulating section 55 and a display section 56.

The public line network 25 may be used for communication in a plurality of communication modes. Two among the plurality of communication modes described above are data communication and speech communication. A communication protocol of communication using the public line network 25 prescribes such that the communication terminal on the calling side informs of that the communication will be made by using which one among the plurality of communication modes to the communication terminal on the call incoming side at the point in time when the line between the two communication terminals is connected via the public line network 25. Therefore, a control signal which the calling side communication terminal gives to the public line network 25 to request to set a call and a control signal which the public line network 25 gives to the call incoming side communication terminal in response to the control signal of the calling side contain information elements indicating that the communication should be made by using which one of the plurality of communication modes, respectively. The opening side communication terminal 28 can switch the data communication with at least one of the communication modes other than the data communication among the plurality of communication modes.

The information terminal 30 of the reading unit 26 is provided with a function for reading a data file opened to the public on Internet. The data file 58 to be opened to the public within the storage unit 34 has the same format with data files opened to the public on Internet. A data file desired to be provide to a reader at first of a plurality of the data file 58 will be called as a main data file 61 and one or a plurality of data files other than the main data file 61 will be called as a sub-data file 62. There is a case where one or a plurality of sub-data files 62 whose readers are limited are contained in all of the sub-data files 62. There is also a case where a sub-data file having contents related to arbitrary one of the sub-data file 62 corresponds to the arbitrary one among all of the sub-data files 62 whose readers are limited. The sub-data file having the related contents will be called an ancillary data file of the arbitrary sub-data file. The main data file 61 corresponds, for exampl, to a data file of a so-called top page in a home page opened on Internet.

The network control circuit 41 performs processes related to connection and release of a line via the public line network between the network control circuit 41 and the reading side communication terminal 31 or another communication terminal. The communication mode discriminating section 42 judges a communication mode to be conducted by using the line connected by the network control circuit 41 is which one among the plurality of communication modes allowed in the public line network 25. The speech communication modem 44 performs a signal processing related to speech communication based on a communication protocol of the public line network 25. The handset 45 comprises a microphone for transforming sound into analog signals and a speaker for transforming the analog signals into the sound. The hook switch 46 is manipulated by the operator of the reading side communication terminal 31 and outputs either one of so-called on-hook signal and off-hook signal in response to the result of manipulation.

The data communication modem 53 performs processes related to establishment and disconnection of a logical communication path for data communication between the opening unit 24 and the information terminal 30 and performs a signal processing related to the data communication based on the communication protocol of the public line network 25 and the communication protocol of the logical communication path. The N-I/F section 51 is a so-called interface circuit which is interposed between the data communication modem 53 and the communication control section 52 and between the opening side communication terminal 28 and the communication control section 52. The communication control section 52 performs processes related to establishment and disconnection of the logical communication path and performs a process related to transmission of a data file requested for reading in response to a request for reading the data file from the information terminal 30. Signal transmitting/receiving operations between the information terminal 30 and the communication control section 52 are conducted based on the communication protocol used in making data communication between a plurality of computers within Internet.

The operator of the opening unit 24 can manipulate the manipulating section 55. The edit control section 54 performs a process for editing the data file 58 by executing an editing program 59 by responding to the result of the manipulation of the manipulating section 55. The editing process includes operations for creating a new data file, for correcting and deleting the data file 58 within the storage unit 34. The display section 56 displays data related to the process for editing the data file 58.

The explanation hereinafter will be made by supposing the structural elements of the communication system 22 as follows. The public line network 25 will be supposed that it is a line network for transmitting sound, image signals and transmission object data/received by converting respectively into digital signals, i.e., a so-called digital line network. The other communication modes which can be switched by the opening side communication terminal 28, other than data communication, will be supposed to be speech communication and facsimile communication. The plurality of data files stored in the storage unit 34 will be supposed to be so-called hyper-text files. The hyper-text file is a data file in which data is described in the HTML scheme and which is the same scheme as a data file indicating a so-called home page of Internet. The plurality of data files 58 will be supposed to be associated from each other by a so-called anchor. The information terminal 30 will be supposed to be also provided with so-called a WWW (World Wide Web) browser program and to be capable of reading the hyper-text file by executing the program.

The digital line network may be realized concretely by a digital portable telephone line network, a PHS line network or an ISDN. The opening side communication terminal 28 may be realized by a so-called digital telephone, a digital portable telephone terminal or a PHS terminal which can be connected to the ISDN. The information terminal 30 may be realized by a personal computer or a portable information terminal for example. The reading side communication terminal 31 may be realized by a telephone or a so-called modem unit for a computer which can make data communication.

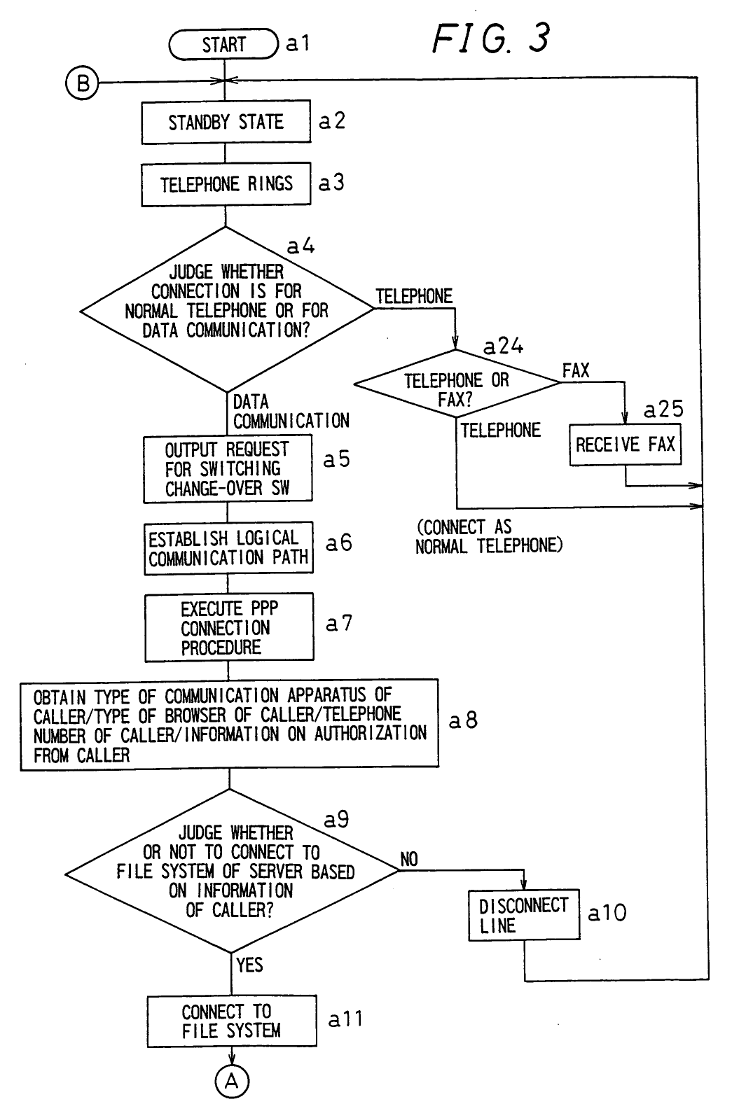

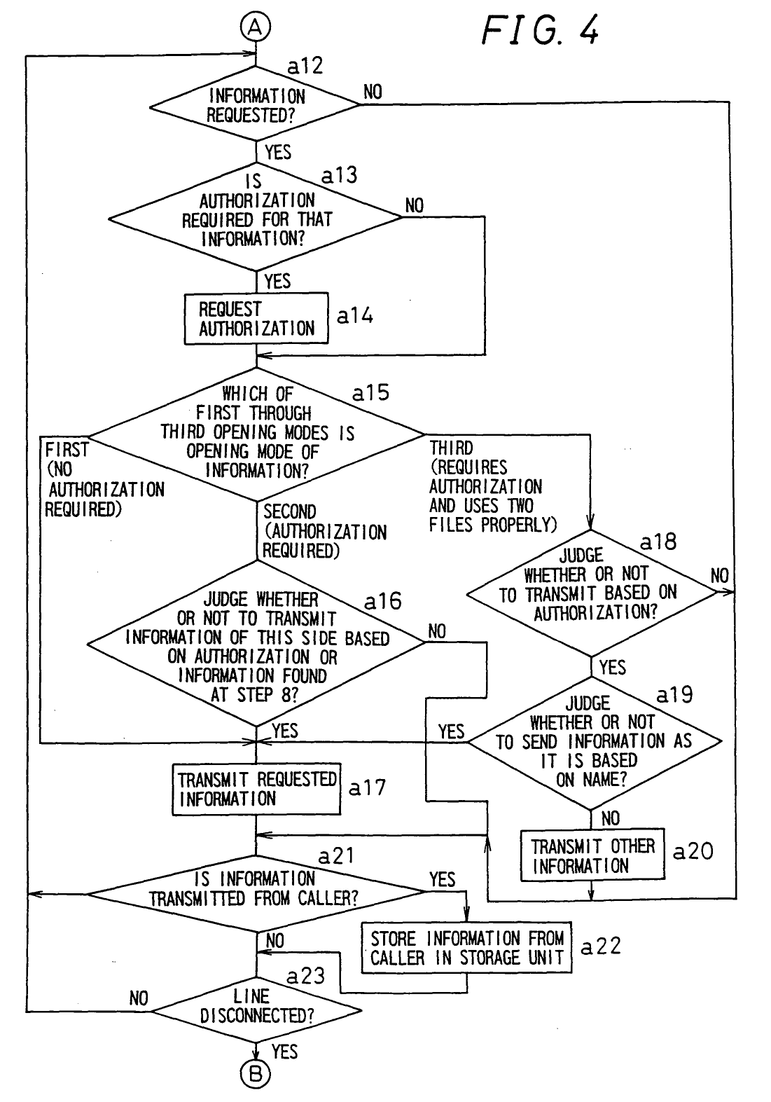

FIGS. 3 and 4 are flowcharts for explaining a receiving operation of the opening unit 24. The operation of the components within the opening unit 24 will be explained in detail by using FIGS. 3 and 4. The detail of the receiving operation of the opening unit 24 depends on the case where it allows the reading unit 26 to read the data file 58 or when it performs speech communication between a communication terminal other than the reading side communication terminal 31. The former case will be called “data reading time” and the latter case will be called “speech communication time” hereinafter.

The receiving operation of the opening unit 24 at the data reading time will be explained at first. When electrical power is supplied to the opening unit 24, the process advances from step a1 to step a2. In step a2, the opening unit 24 waits for a request for connecting a line to the opening side communication terminal 28 from the reading side communication terminal 31 or another communication terminal. That is, after when electrical power is supplied, the opening unit 24 enters the standby state and waits for a phone to the opening side communication terminal 28.

The information terminal 30 causes the reading side communication terminal 31 to dial a telephone number of the opening side communication terminal when the operator of the reading unit 26, i.e., the reader tries to read the data file 58 of the opening unit 24. As a result, a call setting control signal for requesting to set a call is given from the reading side communication terminal 31 to the network control circuit 41 of the opening side communication terminal 28 via the public line network 25. The process advances from step a2 to step a3 at the point in time when the opening side communication terminal 28 receives the call setting control signal.

Responding to the call setting control signal, the communication mode discriminating section 42 discriminates whether a communication mode requested from the communication terminal of the caller, i.e., the reading side communication terminal 31, is data communication or not based on the call setting control signal at step a3. To that end, the communication mode discriminating section 42 compares an information element for indicating the communication mode requested within the call setting control signal with a predetermined information element for requesting data communication. When those two information elements coincide, the communication mode discriminating section 42 judges that the data communication is requested. It also judges that another communication mode other than the data communication is requested when they do not coincide. The result of discrimination of the communication mode is given from the communication mode discriminating section 42 to the communication control section 52 via the N-I/F section 51.

The information element for requesting data communication is defined based on the communication protocol of the public line network 25 and is stored in advance within the communication mode discriminating section 42. When the public line network 25 is the PHS network for example, the call setting control signal corresponds to a so-called call setting message and the information element for requesting data communication corresponds to a code indicative of information transfer capability within a transmitting capability information element within the call setting message.

Based on the result of discrimination, the communication control section 52 decides whether the common contact 49 of the switching circuit 43 should be connected to the other individual contact 48 at step a4. When the reading unit 26 reads the data file, the reading side communication terminal 31 requests data communication. When the requested communication mode is data communication, the process advances from step a4 to step a5. When the requested communication mode is the communication mode other than the data communication, the process advances from step a4 to step a24.

Responding to the call setting control signal, the communication control section 52 returns a response signal of the call setting control signal to the reading side communication terminal 31 via the public line network 25 at step a5. As a result, a line for communication is automatically connected between the opening side communication terminal 28 and the reading side communication terminal 31 at the point in time before the hook switch 46 of the opening side communication terminal 28 is manipulated, i.e., at the point in time when the opening side communication terminal 28 is in the so-called on-hook state. Further, the communication control section 52 generates a switching control signal for switching the switching circuit 43 and gives it to the switching circuit 43 via the N-I/F section 51. Responding to the switching control signal, the switching circuit 43 switches the individual contact connected with the common contact 49 from the first individual contact 47 to the second individual contact 48. As a result, the network control circuit 41 is connected with the data communication modem 53 via the switching circuit 43.

Next, a signal for establishing a logical communication path for the data communication is transmitted/received between the data communication modem of the reading unit 26 and via the reading side communication terminal 31, the public line network 25 and the opening side communication terminal 28 the data communication modem 53 within the opening unit 24 at step a6. The transmitting/receiving operation of the signal between those two data communication modems is conducted based on the communication protocol related to the data communication of the public line network 25 for example. Further, a signal for establishing the logical communication path for the data communication is transmitted/received between the information terminal 30 of the reading unit 26 and the communication control section 52 of the opening unit 24 via the reading side communication terminal 31, the public line network 25 and the opening side communication terminal 28 at step a7. The transmitting/receiving operation of the signal between the information terminal 30 and the communication control section 52 is conducted via the reading side communication terminal 31 and the public line network 25 based on a communication protocol used when the information terminal 30 makes data communication with a computer within a network of a provider. The communication protocol is PPP (Point-to-Point Protocol) for example.

As a result of these processes, the logical communication path is established between the information terminal 30 and the communication control section 52 at the point in time when the process of step a7 ends. The logical communication path prescribes, for example, a method for detecting an error in a transmitted/received digital signal, procedures concerning on selection, setting and release of a communication path of the digital signal, a procedure for confirming an arrival of the digital signal and others. Thereby, the data communication is enabled between the information terminal connected to the communication terminal of the caller, i.e., the information terminal 30, and the data communication system 21.

After establishing the logical communication path, the information terminal 30 sends a read request signal for requesting to read a data file to the opening unit 24. The read request signal contains a specification of either one data file to be read and a request for transmitting the data file. In this case, the data file which the information terminal 30 requests to read may be either one among the data files 58 to be read within the storage unit 34 or may be a data file other than all of the data files 58. The information terminal 30 also transmits environmental information of the information terminal 30 itself together with the read request signal. The environmental information indicates an environment related to reading of the data file in the information terminal 30.

The communication control section 52 receives the read request signal and the environmental information at step a8. The communication control section 52 also obtains an authorization obtained in the processes for establishing the logical communication path at steps a6 and a7 and a telephone number obtained in the process for connecting the line at step a3 as personal information of the reader. The authorization is a data set for identifying the reader and is composed of the name of the reader and a password defined by the reader. It is noted that when the public line network 25 is the PHS line network, the telephone number is indicated by a calling number information element identifier within a calling number information element within the call setting message. The personal information and the environmental information are conditions for judgment used by the communication control section 52 in judging whether or not the data communication should be started.

Based on the conditions of judgment, the communication control section 52 judges whether or not to start the data communication at step a9. In concrete, the communication control section 52 compares the condition of judgment of one or a plurality of persons who should be allowed to have the data communication with the data communication system 21 with the condition of judgment of the above-mentioned reader. The condition of judgment of everyone who should be allowed to have the data communication is stored in the communication control section 52 for example in advance.

When the condition of judgment of the above-mentioned reader does not coincide with any one of the conditions of judgment of everyone who should be allowed to have the data communication, the process advances from step a9 to step a10. The communication control section 52 disconnects the logical communication path at first, causes the network control circuit 41 to conduct a line disconnecting process and returns the switching circuit 43 in the initial state at step a10. As a result, the line is released. After releasing the line, the opening unit 24 returns to the standby state at step a2.

When the condition of judgment of the above-mentioned reader coincides with the condition of judgment of any one among the everyone who should be allowed to have the data communication, the process advances from step a9 to step a11. As a result, the communication control section 52 causes the data communication modem 53 to start to control processes for transmitting/receiving signals related to the data communication. On and after step a11, the opening side communication terminal 28 is put into the state in which it passes the signals related to the data communication via the network control circuit 41 and the switching circuit 43 until the point in time when a call disconnection control signal related to disconnection is given to the line from the reading side communication terminal 31.

A concrete transmitting procedure of the opening unit 24 in transmitting an arbitrary data file or signal to the reading unit 26 is performed as follows while the processes at steps a11 through a23 are conducted. At first, the communication control section 52 gives the data file or the signal to the data communication modem 53 via the N-I/F section 51. The data communication modem 53 converts the data file or the signal to digital signals based on the communication protocol of the public line network 25 and the communication protocol of the logical communication path. The converted data file or signal is given to the information terminal 30 via the opening side communication terminal 28, the public line network 25 and the reading side communication terminal 31. A concrete receiving procedure of the opening unit 24 in receiving an arbitrary data file or signal transmitted from the reading unit 26 is performed as follows while the processes at steps a11 through a23 are conducted. The arbitrary data file or signal has been converted into the digital signal in the information terminal 30 and the digital signal is given to the data communication modem 53 via the reading side communication terminal 31, the public line network 25 and the opening side communication terminal 28. Based on the communication protocols of the public line network 25 and the logical communication path, the data communication modem 53 processes the digital signal to regenerate the data file or the signal and gives the processed data file or signal to the communication control section 52 via the N-I/F section 51. A concrete explanation of the transmitting and receiving procedures will be omitted in the explanation of steps a11 through a23.

The communication control section 52 connects the information terminal 30 with the file system of the server 33 at step a11. The file system is a function for reading/writing the data files within the storage unit 34 in the server 33. A process for connecting the information terminal 30 with the file system is conducted approximately as follows. At first, the communication control section 52 judges whether or not the data file requested to be read is any one among the data files 58 to be transmitted within the storage unit 34. When it is so, the communication control section 52 reads the requested data file 58 out of the storage unit 34 to transmit to the information terminal 30. When the requested data file is a data file other than all of the data files 58 to be transmitted, the communication control section 52 reads the main data file 61 within the storage unit 34 to transmit to the information terminal 30 regardless what is the requested data file is. The information terminal 30 displays the given data file after restoring it based on the two communication protocols. As a result, the information terminal 30 can obtain either one among the data files 58 to be opened to the public in the opening unit 24 just by requesting an arbitrary data file.

When the reader tries to obtain another data file from the opening unit 24, the information terminal 30 transmits a read request signal for requesting to read the data file to the communication control section 52. After ending the process at step a11, the communication control section 52 judges whether or not the read request signal has been given from the information terminal 30 at step a12. When no read request signal has been given, the process advances from step a12 to step a21. When the read request signal has been given, the process advances from step a12 to step a13.

Based on the read request signal, the communication control section 52 checks which one among all of the data files 58 to be opened to the public has been requested at first at step a13 and checks also the opening mode of the data file. When the data file requested to be read is one other than all of the data files 58 to be opened to the public, the communication control section 52 assumes that the main data file 61 is requested to be read. There are three types of opening modes of the sub-data file 62. A sub-data file in the first opening mode is opened to an unspecified number of readers. A number of persons who can read a sub-data file in the second opening mode is defined to one or a plurality of persons in advance. A plurality of persons who can read a sub-data file in the third opening mode is defined in advance and a part of persons among those who can read the data file is defined so as to read the ancillary data file of the sub-data file instead of the sub-data file. The opening mode of the main data file 61 is always the first opening mode.

Accordingly, the communication control section 52 judges whether or not readers of either one data file 58 requested (hereinafter abbreviated as a requested file) are limited, i.e., whether or not the reader need to be authorized to read the requested file, at step a13. When the reader needs to be authorized, the process advances from step a13 to step a14 and when the reader needs not be authorized, the process advances from step a13 to step a15.

When the readers of the requested file are limited, the communication control section 52 gives an authorization request signal for requesting the authorization of the reader to the information terminal 30 at step a14. In response to the authorization request signal, the information terminal 30 gives the authorization of the reader to the communication control section 52. After obtaining the authorization, the communication control section 52 judges the opening mode of the requested file, i.e., which one among the first through third opening modes is, at step a15. When it is the first opening mode, the process advances from step a15 to step a17. When it is the second opening mode, the process advances from step a15 to step a16. When it is the third opening mode, the process advances from step a15 to step a18.

When the opening mode of the requested file is the second opening mode, the communication control section 52 judges at step a16 whether or not the requested file should be given to the information terminal 30 based on the condition of judgment of the reader obtained at step a8 and on the authorization of the reader obtained at step a14. In concrete, the communication control section 52 compares the condition of judgment and the authorization of one or a plurality of persons who should be allowed to read the requested file with the condition of judgment and the authorization of the above-mentioned reader, respectively. The condition of judgment and the authorization of all of the persons who should be allowed to read the requested file are stored in the communication control section 52 for example in advance. When the condition of judgment and the authorization of the above-mentioned reader coincide with the condition of judgment and the authorization of either one of all of the persons who should be allowed to read the requested file, respectively, the process advances from step a16 to step a17. When the condition of judgment and the authorization of the above- mentioned reader does not coincide with the condition of judgment and the authorization of all of the persons who should be allowed to read the requested file, the process advances from step a16 to step a21 by skipping step a17.

When the opening mode of the requested file is the third opening mode, the communication control section 52 judges at step a18 at first whether or not to transmit the requested file to the information terminal 30 based only on the authorization of the operator obtained at step a14. In concrete, the communication control section 52 compares authorization of one or a plurality of persons who are allowed to read the requested file with the authorization of the above-mentioned reader. The authorization of all of the persons who should be allowed to read the requested file is stored in the communication control section 52 for example in advance. When the authorization of the above-mentioned reader coincides with the authorization of either one of all of the persons who should be allowed to read the requested file, the process advances from step a18 to step a19 and when the authorization of the above-mentioned reader does not coincide with any one of the above authorization of all of the persons, the process advances from step a18 to step a21.

Next, the communication control section 52 judges at step a19 whether or not to transmit the requested file or the ancillary data file of the requested file to the information terminal 30 based only on the name within the authorization of the reader. In concrete, the communication control section 52 compares the name of one or a plurality of persons to whom the requested file should be given with the name within the authorization of the reader. The names of all of the persons to whom the requested file should be given are stored in the communication control section 52 for example in advance. When the name within the authorization of the reader coincides with a name of one person among the all of the persons to whom the requested file should be given, the process advances from step a19 to step a17 and when the name within the authorization of the reader does not coincide with any one of the above names of all of the persons, the process advances from step a19 to step a20.

In step a17, the communication control section 52 reads the requested file from the storage unit 34 to give to the information terminal 30. After transmitting the requested file, the process advances from step a17 to step a21. In step a20, the communication control section 52 reads the ancillary data file of the requested file from the storage unit 34 to give to the information terminal 30. After transmitting the ancillary data file, the process advances from step a20 to step a21. When a data file in the second opening mode is requested to be read and the condition of judgment and the authorization of the reader do not coincide with any one of the condition of judgment and the authorization of all of the above persons as described above, and when the sub-data file in the third opening mode is requested to be read and the authorization of the reader does not coincide with the authorization of all of the above persons, the process at step a17 is not conducted. As a result, the requested file is not given to the information terminal 30 in those two cases.

In step a21, the communication control section 52 judges whether or not a data file given from the information terminal 30 to the communication control section 52 exists. When there is the given data file, the process advances from step a21 to step a22 and when there is no data file, the process advances to step a23. The communication control section 52 stores the given data file in the storage unit 34 at step a22. After storing the data file, the process advances from step a22 to step a23. The communication control section 52 judges whether or not the line between the reading side communication terminal 31 and the opening side communication terminal 28 is disconnected at step a23. When it is not disconnected, the process returns from step a23 to step a12. As a result, the processes of steps a12 through a23 are repeated by a plurality of times.

The information terminal 30 disconnects the logical communication path and causes the reading side communication terminal 31 to implement a process for disconnecting the line at the point in time when the reader ends reading of the desired data file. As a result, the line for the communication is released. The network control circuit 41 implements the above-mentioned process for releasing the line in the opening unit 24 at the same time when the communication control section 52 implements the processes of steps a12 through a23 in the opening unit 24. After releasing the line, the process returns from step a23 to step a2 at the point in time when the judgment at step a23 is made. The operation in reading data is carried out as described above.

Next, an operation in communicating by voice will be explained. When the opening unit 24 in the standby state at step a2, the process advances from step a2 to step a3 at the point in time when a call setting control signal is given from the communication terminal of a caller to the network control circuit 41 of the opening side communication terminal 28 via the public line network 25. The operation of the communication mode discriminating section 42 at step a3 is equal with that in reading data described above. The result of discrimination of the communication mode obtained as a result is given from the communication mode discriminating section 42 to the communication control section 52 via the N-I/F section 51. Because speech communication is required in communicating by voice, the communication control section 52 judges that the requested communication mode is not data communication based on the result of discrimination at step a4. As a result, the process advances from step a4 to step a24. Based on the result of discrimination, the communication control section 52 judges whether the requested communication mode is speech communication or facsimile communication at step a24.

When the requested communication mode is facsimile communication, the process advances from step a24 to step a25. The communication control section 52 implements a control sequence for the facsimile communication at step a25. As a result, a line for the facsimile communication is connected with the communication terminal of the caller and signals representing an image given from the communication terminal of the caller are stored in the storage unit 34. After obtaining the signals representing the image, the communication control section 52 causes the network control circuit 41 to implement the process for disconnecting the line. After disconnecting the line, the process returns from step a25 to the standby state at step a2.

When the requested communication mode is speech communication, the communication control section 52 returns from step a24 to step a2 without generating the switching control signal described above. As a result, the state in which the network control circuit 41 is connected with the speech communication modem 44 via the switching circuit 43 is kept as it is. Therefore, the network control circuit 41 waits until the hook switch 46 is manipulated and connects a line in response to the so-called off-hook signal from the hook switch 46 at the point in time when the hook switch 46 is manipulated. After the line is connected, digital signals transmitted/received between the communication terminal of the caller and the speech communication modem 44 via the public line network 25 and analog signals transmitted/received between the handset and the speech communication modem 44 are processed by the speech communication modern 44 based on the signaling protocol of the public line network 25 during the speech communication. Finally, the network control circuit 41 implements the process for disconnecting the line in response to a control signal for disconnecting the line given from the communication terminal of the caller or the so-called on-hook signal from the hook switch 46 at the point in time when that control signal is given or when the hook switch 46 is manipulated. As a result, the line is released. The operation in communicating by voice is implemented as described above.

A first procedure of the process for connecting to the file system at step a11 will be explained below concretely. It is noted that the following explanation will be given by assuming that TCP/IP (Transmission Control Protocol/Internet Protocol) is used as the subordinate protocol within the communication protocol between the information terminal 30 and the communication control section 52 and that the information terminal 30 operates based on a connecting program for connecting the information terminal 30 to Internet by means of dial-up IP connection. It is also assumed that the domain name of the server 33 is defined to be equal with the telephone number of the opening side communication terminal 28.

The information terminal 30 creates a so-called URL (Uniform Resource Locator) as a signal containing the read request signal described above and the condition of judgment described above. The URL is indicated concretely by a character string of

“http://server/file.html?parameter1&parameter2”, wherein “server” corresponds to the domain name of the server opening the requested data file and “file.html” corresponds to the file name of the requested data file. The character string in the above-mentioned case means that the data file whose file name on the server whose domain name is “server” is “file.html” is obtained by using “HTTP” and at that time, parameters of “parameter1” and “parameter2” will be given to “file.html”. In the present embodiment, the information terminal 30 writes a character string indicating the condition of judgment described above as the above-mentioned parameters. The domain name may be or may not be the telephone number of the server 33 of the opening unit 24 itself. The file name may be or may not be also the file name of the requested data file itself.

Next, the information terminal 30 transmits the URL to a standard DNS (Domain Name System) server preset as a reference of the URL in the information terminal 30 with a procedure for transmitting the URL. The standard DNS server is a DNS server which the information terminal 30 inquires the URL on Internet for example. Since the information terminal 30 is allowed to have the data communication only with the server 33 at the point in time of step a11, the transmitted URL is given to the communication control section 52.

After being given the URL, the communication control section 52 judges whether or not the data file required by the URL is either one of the data files 58 to be opened to the public within the storage unit 34. When it is so, the communication control section 52 returns an IP (Internet Protocol) address for specifying the requested data file 58 within the opening unit 24 to the information terminal 30 by the same procedure as the standard DNS server described above. When there is no such requested data file among all of the data files 58 to be opened to the public, the communication control section 52 returns an IP address for specifying the main data file 61 within the opening unit 24 to the information terminal 30 by the same procedure as the standard DNS server.

After being returned the IP address, the information terminal 30 requests the computer specified by the returned IP address to transmit the data file specified by the IP address. In this case, because the returned IP address is what always specifies either one among the data files 58 to be opened to the public within the opening unit 24, when the IP address is used, either one among the data files 58 maybe always requested. As a result, the communication control section 52 gives either one of the data files 58 to be opened to the public to the information terminal 30.

Because the communication control section 52 operates by the procedure described above, the information terminal 30 can obtain the data file from the opening unit 24 just by operating based on the connecting program for connecting the information terminal 30 to Internet by means of the dial-up IP connection. That is, the reader can obtain the data file 58 from the opening unit 24 by the procedure for reading a data file opened to the public on Internet, e.g., a data file in the hyper-text form.

There is also a case where the information terminal 30 is arranged so that the information process unit automatically obtains a data file specified by the predetermined URL at the point in time when the logical communication path is established. In this case, the information terminal 30 transmits the predetermined URL automatically to the standard DNS server at that point in time. The communication control section 52 is arranged so as to return the IP address for specifying the main data file 61 within the opening unit 24 when there is no requested data file among all of the data files 58 to be transmitted, so that it returns the URL for specifying the main data file 61 to the information terminal 30. As a result, the information terminal 30 automatically requests the main data file 61.

Thereby, when the information terminal 30 is arranged so as to automatically obtain an arbitrary data file at that point in time in the communication system 22 of the present embodiment, the main data file 61 is given automatically to the Information terminal 30 after the logical communication path is established. As a result, from the viewpoint of the reader, it seems that the main data file 61 is given automatically just by causing the reading unit 26 to phone to the opening unit 24. As a result, the manipulation of the reader related to reading the data file to be read within the opening unit 24 may be reduced.

As a second concrete procedure of the process for connecting with the file system, it is possible for the information terminal 30 to set the server 33 of the opening unit 24 as the reference server, instead of the standard DNS server, and to inquire an arbitrary URL to the server 33. The operation on and after that is the same as the first procedure except of that the communication control section 52 returns the IP address with the same operation as that of the DNS server preset. In this case, because the IP address of the reference DNS server is decided, the communication control section 52 can fix a DNS server which imitates the operation at the point in time when the IP address is returned. As a result, the process of the communication control section 52 is simplified.

Further, as a third procedure of the process for connecting with the file system, it is possible to set the server 33 of the opening unit 24 as a reference DNS server, instead of the standard DNS server, and to set such that the inquiring URL is what requests to read the main data file 61. As compared with the first procedure, the operation thereof on and after that is the same as that of the DNS server preset by the communication control section 52 except of that the IP address for specifying the main data file 61 within the opening unit 24 is always returned. As a result, because the communication control section 52 is not necessary to judge what is the data file requested by the URL, the process of the communication control section 52 is simplified further. Still more, a character string may be used as the read request signal when the information terminal 30 specifies the main data file 61, therefore the specification may be facilitated.

Further, as a fourth procedure of the process for connecting with the file system, it is also possible for the information terminal 30 to directly transmit the IP address itself for specifying the main data file 61 within the opening unit 24, instead of the URL for requesting to read an arbitrary data file. As a result, the communication control section 52 returns the main data file 61 directly instead of returning the IP address. As a result, the process of the communication control section 52 is simplified because it is not necessary to operate as a DNS server.

Practically, it is preferable to use the first and fourth procedures together and to instruct the reader so as to transmit the IP address for specifying the main data file 61 within the opening unit 24. As a result, when the IP address is given, the communication control section 52 can give the main data file 61 instantly and can give the main data file 61 when the reader requests to read an arbitrary data file even if the reader does not know the IP address. As a result, it is possible to reduce the processing amount of the communication control section 52 while allowing the reader to read the data file readily.

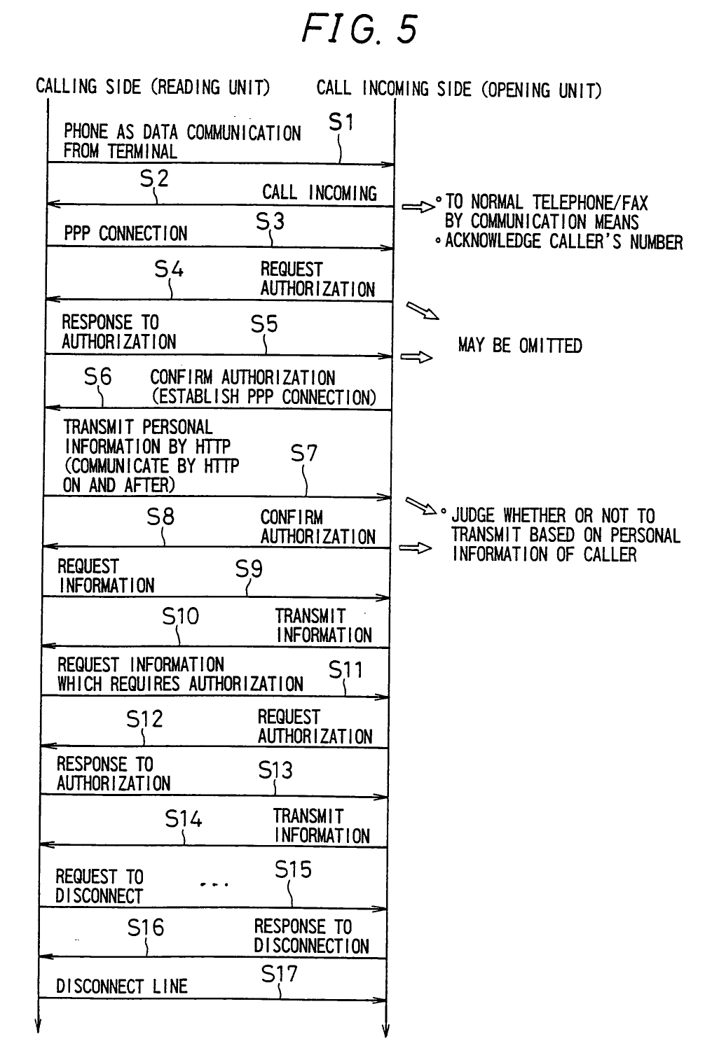

FIG. 5 is a diagram of sequence showing signals transmitted/received between the opening unit 24 and the reading unit 26. Cases of transmitting/receiving the signals in reading data in the communication system 22 will be explained by using FIG. 5. It is assumed in the explanation hereinafter that the superordinate protocol in the communication protocol related to transmission/receiving of the signals between the information terminal 30 and the communication control section 52 is PPP (Point-to-Point Protocol) and HTTP (HyperText Transfer Protocol).

In reading data, the reading unit 26 transmits the call setting control signal S1 from the reading side communication terminal 31 to the network control circuit 41 of the opening side communication terminal 28. Responding to the call setting control signal S1, the opening unit 24 implements the processes of steps a3 through a5. Thereby, a response signal S2 to the call setting control signal S1 is given from the network control circuit 41 to the reading side communication terminal 31. As a result, a line for communication is connected between the opening side communication terminal 28 and the reading side communication terminal 31.

After connecting the line, the process at step a6 is implemented within the opening unit 24. Further, the signal for the process at step a7, i.e., the signal for establishing the logical communication path for the data communication, is transmitted/received between the information terminal 30 of the reading unit 26 and the communication control section 52 of the opening unit 24 based on the PPP. In concrete, a signal S3 requesting to start the PPP connection process is given from the information terminal 30 to the communication control section 52. In response to the signal S3 requesting to start the process, a signal S4 requesting the authorization of the reader is given from the communication control section 52 to the information terminal 30. In response to the signal S4 requesting the authorization, the authorization S5 of the reader is given from the information terminal 30 to the communication control section 52.

In response to the authorization S5 of the reader, the communication control section 52 compares the authorization S5 of the reader with authorization of one or plurality of persons to whom the PPP connection should be allowed. The authorization of all of persons to whom the PPP connection is allowed is stored in the communication control section 52 in advance. The communication control section 52 gives a response signal S6 for establishing the PPP connection to the information terminal 30 only when the authorization S5 of the reader coincides with either one among all of the persons to whom the PPP connection should be allowed. Thereby, the so-called PPP connection, i.e., the logical communication path based on the PPP, is established.

After establishing the logical communication path, the reading unit 26 gives the condition of judgment S7 of the reader to the opening unit 24. When the opening unit 24 uses the authorization of the reader obtained in connecting the PPP and the telephone number of the reading side communication terminal 31 obtained in connecting the line as personal information, only environmental information needs to be transmitted and personal information may be omitted.

Corresponding to the condition of judgment of the reader, the opening unit 24 implements the process at step a9. When it is actually decided to have data communication in the process at step a9, the opening unit 24 implements the process at step a11. As a result, a main data file S8 is given from the opening unit 24 to the reading unit 26. As a result, the reader can know the contents of the main data file S8. The contents also includes the file names of the sub-data files within the storage unit 34. Assume that the file name of the sub-data file in the first opening mode is “hobby.html” and the file name of the sub-data file in the second opening mode is “private.html” for example.

The reading unit 26 sends “http://(telephone number of the opening side communication terminal 28)/hobby.html” for example as a transmit request signal S9 to the opening unit 24 to request to read the sub-data file in the first opening mode. Then, in response to the transmit request signal S9, the communication control section 52 implements the processes of steps a12, a13, a15 and a16. As a result, when the reader is one who is allowed to have data communication with the opening unit 24, the opening unit 24 gives the requested sub-data file S10 to the reading unit 26.

The reading unit 26 sends “http://(telephone number of the opening side communication terminal 28)/private.html” for example as a transmit request signal S11 to the opening unit 24 to request to read the sub-data file in the second opening mode. Then, in response to the transmit request signal S11, the communication control section 52 implements the processes of steps a12 through a14. To that end, an authorization request signal S12 is given from the opening unit 24 to the reading unit 26. In response to that, the reading unit 26 gives an authorization S13 of the reader to the opening unit 24. In response to that, the opening unit 24 implements the processes at steps a15 through a17. As a result, when the reader is one who is allowed to have the data communication with the opening unit 24 and who is allowed to read the sub-data file requested, the opening unit 24 gives the requested sub-data file S12 to the reading unit 26.

The information terminal 30 disconnects the logical communication path at first to end the data communication between the reading unit 26 and the opening unit 24. Further, the reading side communication terminal 31 sends a call disconnect control signal S15 for requesting to disconnect the line to the network control circuit 41 of the opening side communication terminal 28. In response to the call disconnect control signal S15, the network control circuit 41 returns a response signal S16 to the signal S15 to the reading side communication terminal 31. As a result, the line for the communication is released.

When the sub-data file 62 in the second and third opening modes is requested, the communication control section 52 can request the environmental information instead of the authorization. In this case, the reference environmental information indicating an environment which allows to read the sub-data file is defined in advance. The communication control section 52 compares the environmental information of the reader with the reference environmental information instead of the authorization of the reader in the judging processes at steps a13 and a18 and allows the sub-data file 62 to be read only when they coincide.

The environmental information is at least one of the specification of the display of the information terminal 30 and the specification of a data file imaging function of the information terminal 30. The specification of the display of the information terminal 30 may be checked by checking the type of the information terminal 30 itself, i.e., whether the information terminal 30 is a personal computer or a portable information terminal. The specification of the imaging function of the information terminal 30 may be checked by checking the type of the reading program, i.e., the type of the browser, for example.

Whether or not to allow to read the sub-data file 62 or which one of the sub-data file 62 and the ancillary data file of the file should be read is decided corresponding to the specification of the display of the information terminal 30 because two displays whose specification differ have sizes and display standards different from each other and the sub-data file may not be displayed visibly on the two displays when one sub-data file is displayed on each display. Those two judgments are decided corresponding to the browser of the information terminal 30 because the display mode of the hyper-text is different per every browser and the two browsers may not display the sub-data file visibly when one sub-data file is displayed on each of the two kinds of browsers.

An editing process of the data file 58 using the editing unit 35 will be explained below. When the operator manipulates the manipulating section 55 by a method corresponding to the contents to be edited in editing the data file 58. In response to the manipulation result of the manipulating section 55, the edit control section 54 reads an editing program 59 from the storage unit 34 to execute it. As a result, the edit control section 54 edits based on the manipulation result of the operator who manipulates the manipulating section 55. In response to the operation of the edit control section 54, a new data file being created, the existing data file 58 being corrected, a data file to be deleted or the like is displayed on the display section 56. After ending the edition, the result of edition of the data file 58 in the edit control section 54 is reflected automatically on the stored contents of the storage unit 34. For example, the created or corrected data file is stored in the storage unit 34 and the data file to be deleted is deleted from the storage unit 34. As a result, the data file to be opened to the public is also edited by the opening unit 24.

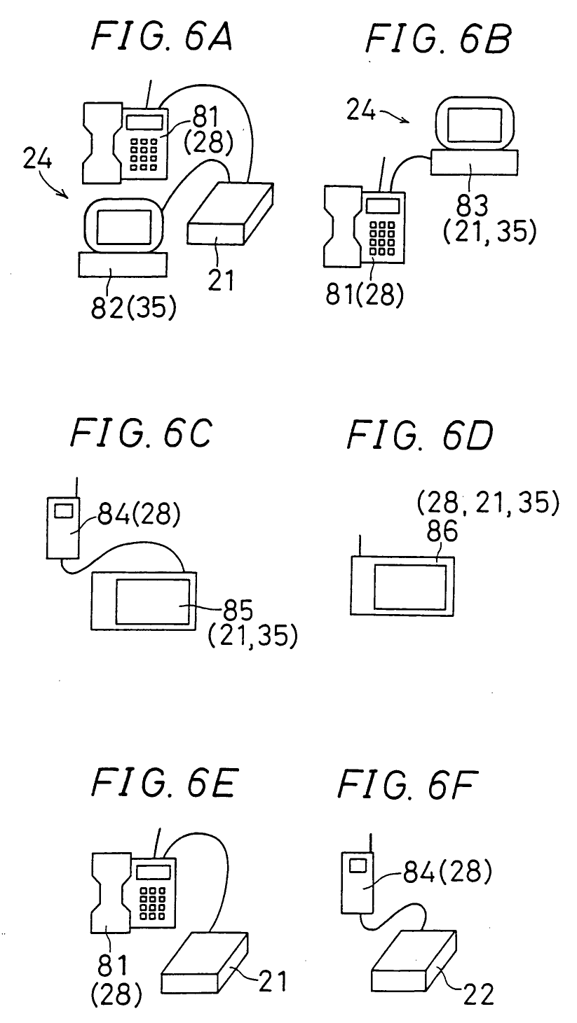

FIGS. 6A through 6F are diagrammatic views respectively showing the concrete structures in manufacturing the opening unit 24 as the finished goods. In the first structure shown in FIG. 6A, a stationary type telephone 81 which is capable of conducting data communication and speech communication is used as the opening side communication terminal 28 and a computer 82 capable of editing the data file 58 is used as the editing unit 35. Therefore, the opening unit 24 of the first structure is constructed by connecting the stationary type telephone 81 and the computer 82 to the data communication system 21.

In the second structure shown in FIG. 6B, the data communication system 21 is realized by one function of a computer 83 provided with a data communication function and a function for editing the data file 58. That is, the opening unit 24 of the second structure is constructed by using the stationary type telephone 81 as the opening side communication terminal 28 and by connecting it to the computer 83. Thereby, the computer 83 can be used both as the data communication system 21 and the editing unit 35.

The data communication system 21 may be realized by a general purpose computer by the following procedure. A software containing a program and data for causing a central operation processing unit of the computer to perform the receiving processes explained in FIGS. 3 and 4 is stored in advance in a storage medium which can be read by the computer. A CD-ROM and a floppy disk may be cited for example as the storage medium. The computer may be operated as the data communication system 21 by mounting the storage medium to the computer, by installing the software within the storage medium to the computer and by causing the central operation processing unit to execute the program within the installed software. Thereby, the central operation processing unit and memories within the computer operates as the communication control section 52, so that the computer operates as the data communication system 21 as a whole. Thereby, the data communication system may be realized readily by using the general purpose computer.

The opening unit 24 of the third structure shown in FIG. 6C is the same as the opening unit 24 of the second structure except of that the stationary type telephone 81 is changed to a portable telephone terminal 84, e.g., a digital portable telephone terminal or a PHS terminal, which can switch data communication and speech communication and that the computer 83 which can edit the data file is replaced with a portable information terminal 85 which can perform an editing process. Thereby, the portable information terminal 85 can be used both as the data communication system 21 and the editing unit 35. The opening unit 24 of the fourth structure shown in FIG. 6D is one that the components for realizing the same communication function as the above-mentioned portable telephone terminal 84 are contained in a portable information terminal 86 which can edit the data file 58 and the above-mentioned software is installed therein. The opening unit 24 of the third and fourth structure is suited for carrying around.

It is noted that although the opening unit 24 is provided with the editing unit 35 in the present embodiment, the editing unit 35 may be omitted from the opening unit 24 if no process for editing the data file 58 is carried out after all of the data files 58 created in the computer or the portable information terminal for example are stored in the storage unit 34 once. In this case, it is possible to connect only the stationary type telephone 81 and the data communication system 21 like the opening unit 24 in the fifth structure shown in FIG. 6E or to connect only the portable telephone 84 and the data communication system 21 like the opening unit 24 in the sixth structure shown in FIG. 6F.

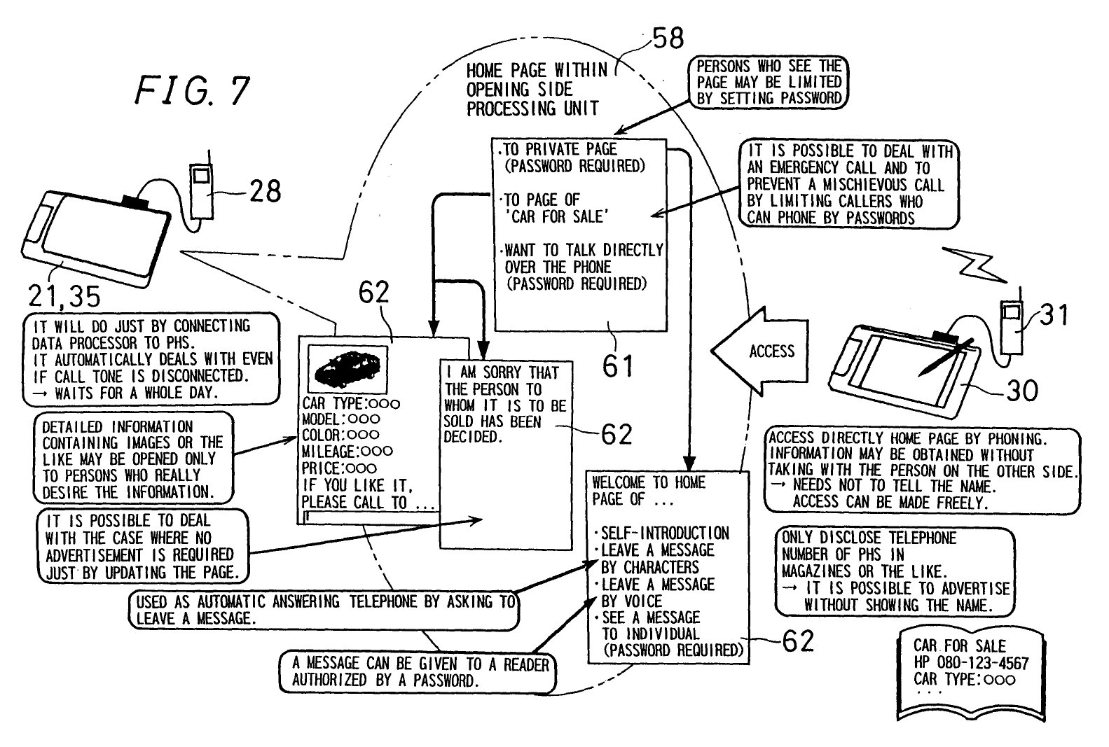

FIG. 7 shows examples of utilization of opening of the data files 58 using the communication system 22 of the present embodiment. It is assumed in FIG. 7 that the opening side and reading side communication terminals 28 and 31 are PHS and that the data file constitutes a so-called home page.

The person who tries to open the data file 58 to the public, i.e., the opener of the home page, stores the data file 58 in the storage unit 34 of the data communication system 21 and connects the data communication system 21 to the opening side communication terminal 28. The opener also opens the telephone number of the opening side communication terminal 28 and an outline of information described in the data file 58 to an unspecified number of persons by using a media such as magazines and newspapers.

The reader of the data file 58 phones the communication terminal of the disclosed telephone number, i.e., to the opening side communication terminal 28, by using the reading side communication terminal 31 to request data communication. At the point in time when the data communication is requested from the reading unit 26, the opening unit 24 connects a line automatically with the reading unit 26 to start the data communication.

Thereby, the opener can let the unspecified number of persons to read the data file 58 just by storing the data file 58 in the storage unit of the data communication system 21 and by connecting the data communication system 21 to the opening side communication terminal 28. It is possible to disclose at least only the telephone number of the opening side communication terminal 28 and not to disclose the name of the opener in the media such as magazines. Therefore, it is possible to advertise the contents of the data file 58 without showing the name of the opener. Further, the reader is allowed to read the data file without talking with the opener. Therefore, it is not necessary for the reader to tell the name to the opener and the reader can request to read the data file 58 to the opening unit 24 easily.

Further, because the opening unit 24 implements the process related to the disclosure of the data file 58 automatically when the data communication is requested, the opener needs not to respond to the phone to the opening side communication terminal 28. Therefore, it is possible to shut off a calling tone of the opening side communication terminal 28 in advance for example. From these facts, the opening unit 24 can wait for the request to read the data file 58 for a whole day. It is almost the same situation that a storage unit in which a data file to be opened to the public is stored is always connected to Internet.

The reading unit 26 is connected to the opening unit 24 by the method of connecting with Internet via the provider and reads the data file 58 within the opening unit 24 by the same method that a data file opened to the public on Internet are read. Accordingly, the reading unit 26 may be a unit which allows the so-called dial-up IP connection and which is capable of reading the data file opened to the public on the Internet. That is, it may be realized by an ordinary personal computer and a portable information terminal which are capable of utilizing Internet.

Thereby, the opening unit 24 can open the data file stored in the data communication system 21 to the personal computer and the portable information terminal which are capable of utilizing Internet without connecting the data communication system 21 always to Internet. Further, because it does not utilize Internet to open the data file, the reader of the data can read the data file 58 stored in the data communication system 21 without utilizing Internet itself as long as the reader can utilize the personal computer and the portable information terminal capable of utilizing Internet. That is, the data communication system 21 can open the data file to persons who have not made a contract with the provider or persons who cannot use the server in Internet. Thereby, it is possible to open the data file 58 to more persons in the case of opening the data file by using the opening unit 24 than in the case of opening the data file on Internet.

The method for opening the data file 58 by using the communication system 22 of the present embodiment is easier than the method for opening the data file by using the communication system 1 of the prior art. It is because, even if the data file has been edited in a unit not connected to Internet, the communication system 22 of the present embodiment does not require the data file to be transferred to the server within Internet from the unit. Therefore, the opener can update the data file 58 readily. The edition of the data file is facilitated further when the editing unit 35 is provided within the opening unit 24. Therefore, when an item advertised in the present data file 58 needs to be changed for example, the opener can change the contents by correcting the data file 58 right away.

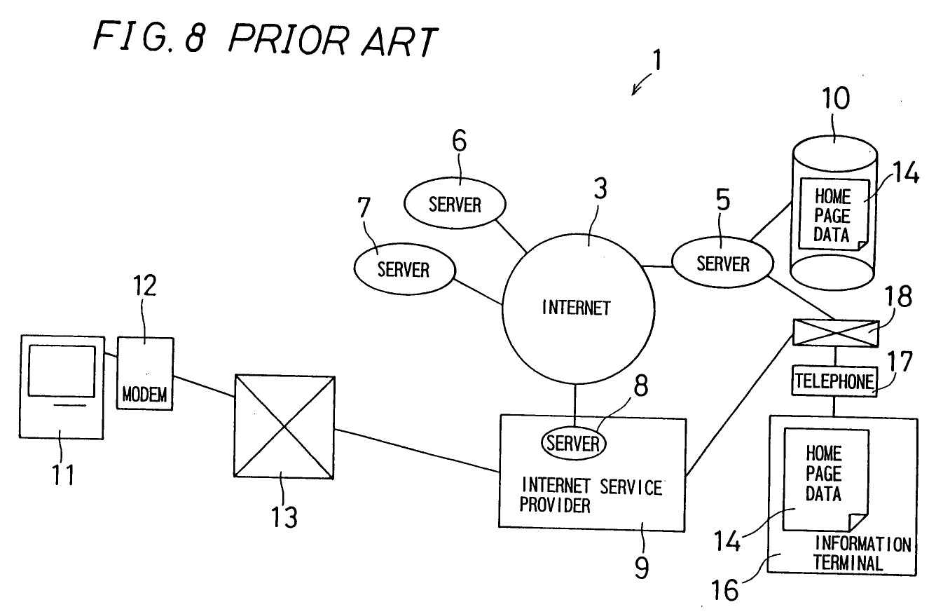

The structure of the communication system 22 for opening the data file 58 by using the data communication system 21 described above is simpler than the structure of the communication system 1 of the prior art shown in FIG. 8. It is because the components for connecting the information terminal, i.e., the data communication system 21, with Internet are eliminated from the communication system 22 of the present embodiment, as compared to the communication system 1 of the prior art since the data file 58 is not opened on Internet. Thereby, it is possible to own the opening unit 24 readily by individual. Still more, because the owner of the data communication system 21 owns the storage unit 34 in which the data files 58 are stored, it is not necessary to make a contract concerning on the connection of Internet and the provider and to make a contract concerning on borrowing of the storage unit with the administrator of the server within Internet. Further, the data communication system 21 is connected to the public line network 25 via the opening side communication terminal 28 which is capable of switching speech communication and data communication. As a result, it is not necessary to connect the data communication system 21 to a dedicated line to always open the data file 58 to the public.

The data communication system 21 also divides data files into a main data file and sub-data files. Therefore, when detailed contents of information to be opened to the public is described in the sub-data file, the detailed contents is opened only to the reader who requests to read the sub-data file. Thereby, the detailed information may be opened only to the person who requires the detailed contents.

Still more, persons who can read the sub-data file are limited by the authorization. Thereby, persons who read a part of the sub-data files for example may be limited by the authorization. Using such function of the opening unit allows the opener to give a message to the specific reader by describing the message from the opener to the specific reader in the sub-data file which can be read only when the reader is authorized and by storing it in the storage unit 34. Moreover, the data communication system 21 has the function of storing the data file given from the reading unit 26 as shown at steps a22 and a23 in the flowcharts in FIGS. 3 and 4, so that a message from the reader may be stored. That is, the opening unit 24 may be used as an automatic answering telephone.

Further, although the main data file 61 is opened to an unspecified number of readers because the opener uses only one opening side communication terminal in general, the readers of the sub-data file 62 are limited corresponding to the condition of judgment. Therefore, when the opener opens a plurality of items to the public by using one opening unit 24, persons who can read each item may be limited separately by describing the detailed contents of each item in the individual sub-data file of the second or third opening mode.

The data communication system 21 of the present embodiment is an illustration of the inventive data communication system and may be embodied in various ways so long as the main operations are equal. In particular, the components composing the communication system 22 and their detailed operations may be realized not by the operations described above but by the other operations as long as the same processing result can be obtained.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A data communication system comprising:
request judging means for judging whether or not a terminal unit of a caller is requesting data communication based on a call signal given from the terminal unit;
connection instructing means for instructing to connect a line for transmitting/receiving signals to/from the terminal unit;
line control means for connecting the line in response to an instruction from the connection instructing means;
transmission/receiving control means for data communication, capable of controlling transmission/receiving of signals indicative of data on the basis of a communication protocol preset for the data communication; and
communication control means, in response to a result of judgement of the request judging means, for, in the case where the data communication is requested, causing the line control means to connect the line to compare an authorization given from the terminal unit via the line with a reference authorization defined in advance and for causing the transmission/receiving control means to start to control the transmission/receiving of the signals only when the authorization coincides-with the reference authorization.

2. The data communication system of claim 1, further comprising:
storing means for storing at least one of predetermined sets of transmission object data,
wherein when the terminal unit requests to transmit data other than the predetermined sets of transmission object data after starting the control of the transmission/receiving of the signal, the communication control means causes the transmission/receiving control means to convert any one of the predetermined sets of transmission object data into signals on the basis of the communication protocol and transmit the signals, and
when the terminal unit requests to transmit any one of the predetermined sets of transmission object data, the communication control means causes the transmission/receiving control means to convert the requested set of transmission object data into signals on the basis of the communication protocol and transmit the signals.

3. The data communication system of claim 1, comprising:
storing means for storing at least one of the predetermined sets of transmission object data,
wherein the terminal unit transmits the request to transmit any one of the predetermined sets of transmission object data and one or more predetermined conditions of judgment, after starting the control of the transmission/receiving of the signal; and
wherein the communication control means judges whether or not the transmitted one or more conditions of judgment satisfy one or more predetermined reference conditions for allowing the requested set of transmission object data to be transmitted in response to the request from the terminal unit and only when the one or more conditions of judgment satisfy the one or more predetermined reference condition the communication control means causes the transmission/receiving control means to convert the requested set of transmission object data into signals on the basis of the communication protocol and transmit the signals.

4. The data communication system of claim 3, wherein one of the one or more conditions of judgment is the specification of the terminal unit related to processing of the set of transmission object data.

5. The data communication system of claim 3, wherein the terminal unit further comprises imaging means for imaging the set of transmission object data, and one of the one or more conditions of judgment is the specification of the imaging means related to imaging the set of transmission object data.

6. The data communication system of claim 3, wherein the line contains a part of a public line network, and one of the conditions of judgment is an identification number for discriminating the terminal unit within the public line network.

7. The data communication system of claim 3, wherein one of the one or more conditions of judgment is predetermined authorization.

8. The data communication system of claim 3, further comprising storing means for storing at least one of predetermined sets of transmission object data; that the terminal unit transmits the request to transmit any one of the predetermined sets of transmission object data and one or more predetermined conditions of judgment after starting the control of the transmission/receiving of the signal; and that the communication control means judges whether or not the transmitted one or more conditions of judgment satisfy one or more predetermined reference conditions for allowing the requested set of transmission object data to be transmitted in response to the request from the terminal unit and when the one or more conditions of judgment satisfy the one or more predetermined reference condition the communication control means causes the transmission/receiving control means to convert the requested set of transmission object data into signals on the basis of the communication protocol and transmit the signals, and when the one or more conditions of judgment do not satisfy the one or more reference conditions the communication control means causes the transmission/receiving control means to convert transmission object data other than the requested transmission object data into signals on the basis of the communication protocol and transmit the signals.

9. The data communication system of claim 8, wherein one of the one or more conditions of judgment is the specification of the terminal unit related to processing of the set of transmission object data.

10. The data communication system of claim 8, wherein the terminal unit further comprises imaging means for imaging the set of transmission object data, and one of the one or more conditions of judgment is the specification of the imaging means related to imaging the set of transmission object data.

11. The data communication system of claim 8, wherein the line contains a part of a public line network, and one of the conditions of judgment is an identification number for discriminating the terminal unit within the public line network.

12. The data communication system of claim 8, wherein one of the one or more conditions of judgment is predetermined authorization.

13. The data communication system of claim 1, further comprising received-data storage means capable of storing data and that the communication control means stores data indicated by the received signals in the received-data storage means.

14. The data communication system of claim 1, wherein the communication protocol is a communication protocol used for data communication on Internet.

15. A data communication system, capable of making data communication with a terminal unit of a caller via a communication apparatus which comprises connection instructing means for instructing to connect a line for transmitting/receiving signals and line control means for connecting the line with the terminal unit in response to the instruction from the connection instructing means, the data communication system comprising:
request judging means for judging whether or not the terminal unit is requesting data communication on the basis of a call signal given from the terminal unit of the caller;
transmission/receiving control means for data communication, capable of controlling transmission/receiving of signals indicative of data based on a communication protocol preset for the data communication; and
communication control means for causing the line control means to connect the line when the data communication is requested in response to a result of judgment of the request judging means, for comparing authorization given from the terminal unit via the line with reference authorization defined in advance and for causing the transmission/receiving control means to start to control the transmission/receiving of the signals only when the authorization coincides with the reference authorization.

16. A medium storing a communication control program for causing a computer to have data communication with a terminal unit of a caller via a communication apparatus which comprises connection instructing means for instructing to connect a line for transmitting/receiving signals, and line control means for connecting the line with the terminal unit of the caller in response to the instruction from the connection instructing means,
wherein the communication control program causes the computer to judge whether or not the terminal unit is requesting data communication based on a call signal given from the terminal unit, causes the line control means to connect the line when the data communication is requested, causes the computer to compare authorization given from the terminal unit via the line with the reference authorization defined in advance and causes the transmission/receiving control means to start to control the transmission/receiving of the signals indicating data based on a communication protocol preset for data communication only when the authorization coincides with the reference authorization.
